(19) United States
(12) Patent Application Publication
(10) Pub. No.: US 2006/0114172 A1
(43) Pub. Date: Jun. 1, 2006

(54) Method and apparatus for LED based modular display

(75) Inventor: Shiraz M. Shivji, Saratoga, CA (US)

Correspondence Address: HEIMLICH LAW, 5952 DIAL WAY, SAN JOSE, CA, 95129, US

(73) Assignee: Giotti, Inc., Saratoga, CA (US)

(21) Appl. No.: 11/286,536

(22) Filed: Nov. 23, 2005

Related U.S. Application Data
(60) Provisional application No. 60/631,236, filed on Nov. 26, 2004.

(51) Int. Cl. G09G 5/00

(52) U.S. Cl. 345/1.1

(57) ABSTRACT

A method and apparatus for a light emitting device (LED) based modular display have been described.

### RELATED APPLICATION

This patent application claims priority of U.S. Provisional Application Ser. No. 60/631236 filed Nov. 26, 2004 titled “Method and Apparatus for LED Based Modular Display ”, which is hereby incorporated herein by reference. This patent application is related to U.S. application Ser. No. 10/810300 filed Mar. 26, 2004 titled “Method and Apparatus for Light Emitting Devices Based Display”, U.S. Provisional Application Ser. No. 60/584920, and U.S. Provisional Application Ser. No. 60/591110.

### FIELD OF THE INVENTION

The present invention pertains to a method and apparatus for a light emitting device (LED) based modular display. More particularly, the present invention relates to a method and apparatus for a large area LED based electronic display composed of a plurality of smaller LED based display modules (tiles) that are mounted to create a large display.

### BACKGROUND OF THE INVENTION

Large tiled displays have been built using CRTs, backlit LCD displays and projection displays. Projection displays are the most popular form of tiled displays in use today. However, there are significant problems to building large tiled displays using projection technologies. For example, each projector has a slightly different color gamut caused by variations in the light bulb, the color filters, and the digital processing (contrast, brightness and gamma) for each projector.

On the other hand, LED arrays can be made very precisely with respect to specifications of the color wavelength required. It is now possible to match the wavelengths of the output light to within +/−3 nm. The light output from the LEDs is “purer” than the red, green, or blue light output of a lamp and color filters, and has a half power bandwidth of less than 30 nm.

LED based displays are increasingly taking over the markets for large displays used outdoors and in public areas, such as, airports and shopping malls. LEDs have long life times compared with projection bulbs and have excellent color performance. LEDs can be manufactured to provide deeper reds, 635 nm, for example, than is possible with the standard red phosphors (615 nm) used in the NTSC standards based CRT displays. In addition, LEDs have a very high dynamic range leading to excellent color performance.

The displays that are presently being constructed and used employ individually mounted red, green and blue LEDs or modules having a small array of red, green, and blue LEDs. FIG. 3 (Prior Art) shows an M ×N display built using M ×N RGB LED pixel units. Each RGB pixel unit needs a minimum of one red, one green, and one blue LED. Sometimes a single pixel unit is built with 2 red LEDs, 2 green LEDs and 1 blue LED. This is done, for example, in the LEDTRONICS® RGB-1006-001 2×2 pixel module that contains 8 red, 8 green and 4 blue LEDs. Some manufacturers use a single red, green, and blue for an RGB pixel. To display a white color for a particular pixel the luminance value of the red, green, and blue LEDs are driven in the ratio of 0.3, 0.59, and 0.11 respectively. For ease in building large displays, smaller standard modules varying widely in size are used. A few representative samples are, for example, an 8 ×8 pixel unit from LEDTRONICS® model RGB-1004-002 where the pixel pitch is 6 mm and the module size is 47.8 mm ×47.8 mm. BARCO, INC. has a unit, the MiPix-20 a 2 ×2 pixel module that has a pixel pitch of 20 mm and the module is 40.3 mm ×40.3 mm. An example of a larger module is one from Daktronics, Inc., the AF 5010 series 16 ×16 pixel modules with a pixel pitch of 23 mm and a size of 365 mm×365 mm.

To reduce the wiring and complexity in driving individual LEDs, the LEDs in a module are pre-wired to be configured in the common anode or common cathode configuration. The finished display consisting of hundreds of thousands of modules is then energized by scanning the rows or columns or a combination of rows and columns. A representative example of the complexity of such large LED displays is shown by the Coca-Cola® display in Times Square in New York City which was built by Daktronics, Inc. The display consists of 882,112 LED pixels, using 2,646,336 LED diodes, and over 80,000 feet of wiring. This may present a problem.

One can see that the present approaches for creating LED displays is very costly and overly complicated. Another disadvantage of the present approaches is that the viewer can often see the individual red, green, and blue subpixels. This may present a problem.

### BRIEF DESCRIPTION OF THE DRAWINGS

The invention is illustrated by way of example and not limitation in the figures of the accompanying drawings in which:

FIG. 1 illustrates a network environment in which the present invention may be implemented;

FIG. 2 is a block diagram of a computer system which may be used for implementing some embodiments of the invention;

FIG. 3 shows a prior approach;

FIG. 4 shows one embodiment of the present invention showing an LED display engine using columns of Red, Green and Blue LEDs;

FIG. 5A shows one embodiment of the present invention illustrating a block diagram of a modular LED display;

FIG. 5B shows one embodiment of the present invention illustrating a cross-section of a modular LED display;

FIG. 6 shows one embodiment of the present invention in block diagram illustrating a large LED display built from smaller LED display modules;

FIG. 7 shows one embodiment of the present invention showing more details in block diagram form;

FIG. 8 shows one embodiment of the present invention illustrating an LED display engine using a substrate with multiple columns of RGB LEDs and a rotating mirror;

FIG. 9 shows in flowchart form, for one embodiment of the invention, the procedure for alignment of top and bottom pixels to the screen edge;

FIG. 10 shows one embodiment of the invention illustrating the final assembly of LED display modules and adjustment procedures;

FIG. 11 shows one embodiment of the invention illustrating a large LED display built with smaller LED modules; and

FIG. 12 shows one embodiment of the invention illustrating a configuration where adjacent modules have motion in opposite directions.

### DETAILED DESCRIPTION

As used in this description, “LED” or similar terms refers to light emitting devices. There are a variety of light emitting devices, for example, light emitting diodes (commonly referred to as LEDs), visible light emitting lasers, vertical cavity surface emitting lasers (VCSELs), quantum dots, resonant cavity light emitting diodes (RCLEDs), organic light emitting diodes (OLEDs), electroluminescent diodes (ELDs), photon recycling semiconductor light emitting diode, etc. For convenience in illustrating various embodiments of the invention, LED and similar terms will refer to all such Light Emitting Devices, not to just light emitting diodes. That is, our use of LED here includes, light emitting diodes, lasers, etc. Where a distinction is made the text will explicitly use a specific term intended.

In various embodiments of the present invention, the invention utilizes techniques that have been developed for constructing tiled LED based displays in which the seams between the tiles are virtually imperceptible to the human eye under normal viewing conditions.

In one embodiment of the present invention, a large LED display may be built using smaller modules. The modules are built using LEDs in much smaller numbers than would be required if individual LEDs were used for each pixel (for example, as described in U.S. Pat. Application Serial No. 10/810300 filed Mar. 26, 2004 titled “Method and Apparatus for Light Emitting Devices Based Display”, U.S. Provisional Application Ser. No. 60/584920, and U.S. Provisional Application Ser. No. 60/591110). One representative example of this approach creates a 1.2 ft.×1.2 ft. display module providing a resolution of 256×256 pixels and uses in one embodiment 256×3 (768) LEDs and in another embodiment uses 256×3×2 (1536) LEDs instead of the usual 256×256×3 (196,608) LEDs that would be required for a dedicated LED array. Given the reduced number of LEDs used, this approach may reduce the cost and complexity of the display. Additionally, since the pixel position is related to when LEDs are energized in time, in one embodiment, the display image created does not have red, green and blue subpixels that are discernable by the human eye.

In one embodiment of the invention, a large display is built up using the LED display modules described above. The modules are carefully placed so that they are close to (or possibly touching) each other and are aligned top and bottom and on the sides. The tiled display needs to have a nearly invisible joint (seam) between the tiles to be widely acceptable to users. There are 2 conditions that need to be met in order to achieve this:

1. The interpixel gap should be visually identical within and between tiles; and

2. The angular distribution of the intensity of light emitted from a tile should be the same at the left and right and at the top and bottom edges of a tile.

In one embodiment of the present invention, the 2 conditions mentioned above are achieved by adjusting the start and end times of the energization of the LEDs. This adjustment is checked when a module is constructed and is re-checked when the display is assembled with the individual modules. This takes care of the vertical seams or pixels at the columns on the 2 vertical sides of the modules. The horizontal seams are taken care of by construction. During assembly of the module, the distance to the screen from the optics is adjusted until the pixels at the top edge are aligned to the top edge, and the pixels at the bottom edge are aligned to the bottom edge. The uniform brightness requirement is met by lighting up adjacent tiles with a suitable pattern and the intensity is measured. An adjustment is made, if necessary, to reduce the brightness of the brighter module by turning down the brightness by a reduction factor. This reduction factor may be stored in the non-volatile memory of each of the relevant modules, or may be downloaded at startup, or dynamically adjusted periodically during operation.

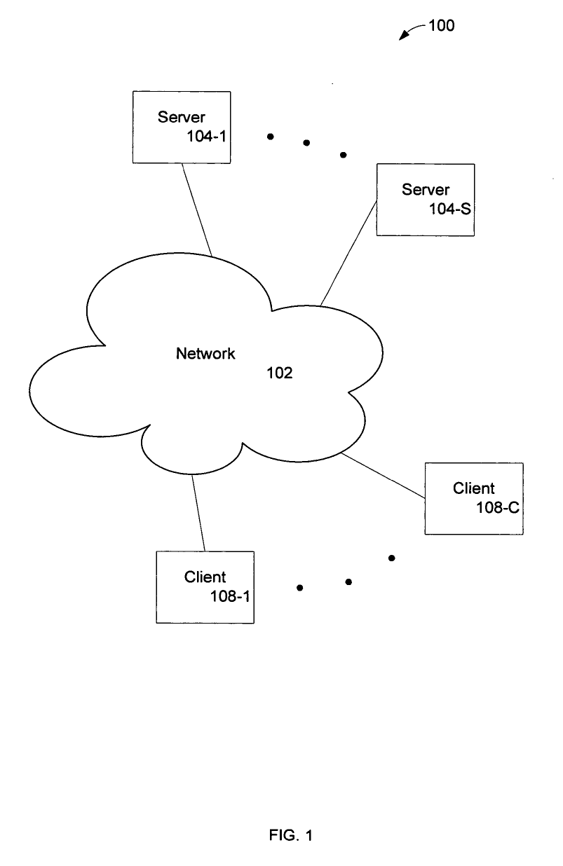

FIG. 1 illustrates a network environment 100 in which the techniques described may be applied. More details are described below.

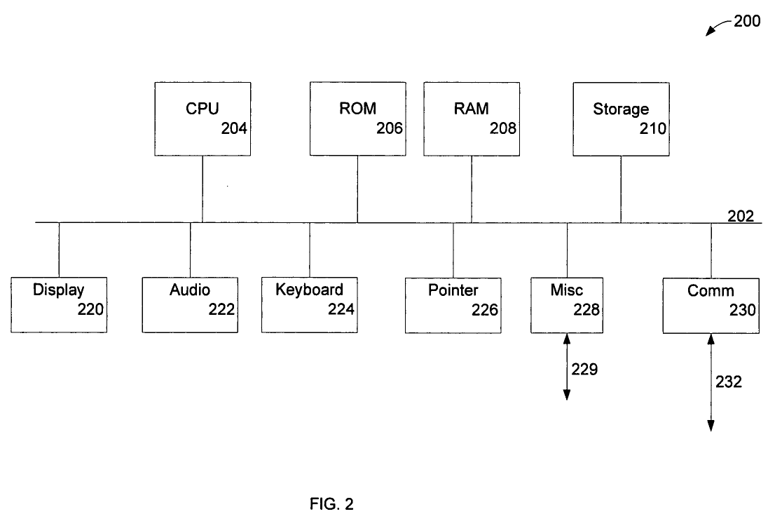

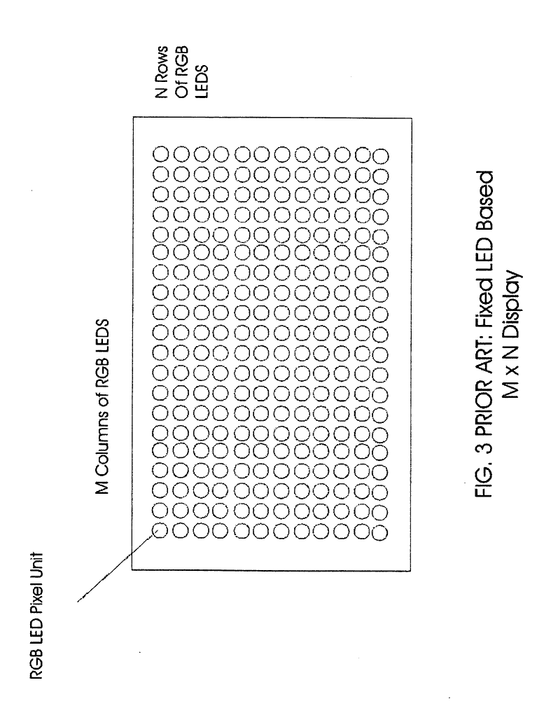

FIG. 2 illustrates a computer system 200 in block diagram form, which may be representative of any of the devices shown in FIG. 1. More details are described below.

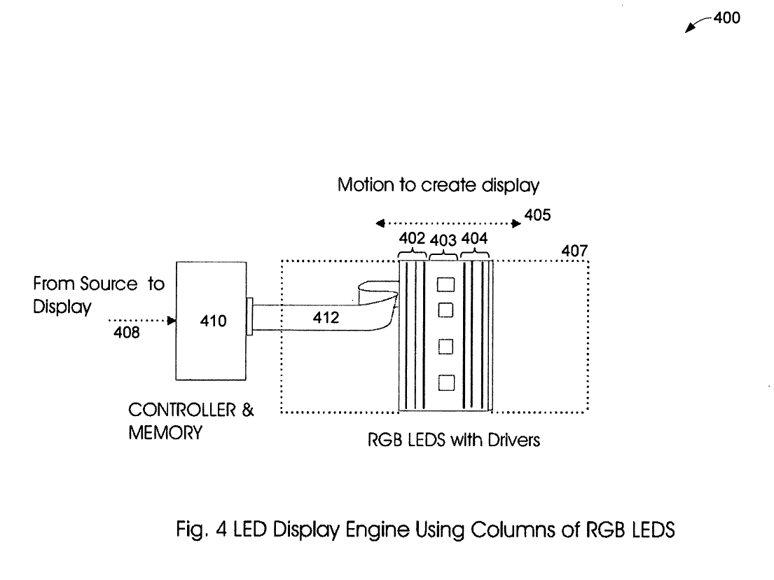

FIG. 4 shows an embodiment of a LED display engine 400 using columns of RGB LEDs (402, and 404). The columns of LEDs (402, and 404) are driven by drivers 403. The LEDs (402, 404) and drivers 403 are moved 405 to cover an area 407. An input source 408 communicates with a controller and memory 410 which communicates via 412 with the drivers 403. This type of embodiment is described in detail in U.S. application Ser. No. 10/810300 filed Mar. 26, 2004 titled “Method and Apparatus for Light Emitting Devices Based Display”, U.S. Provisional Application Ser. No. 60/584920, and U.S. Provisional Application Ser. No. 60/591110.

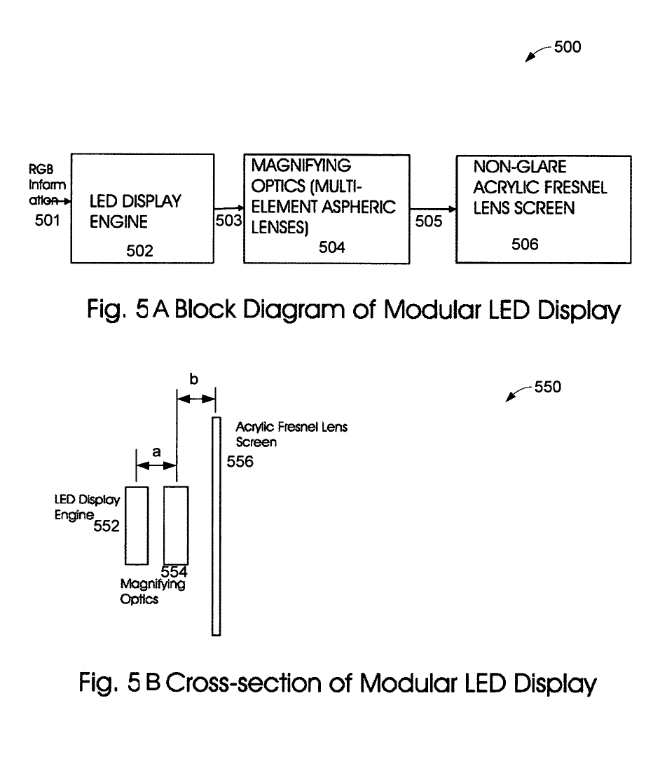

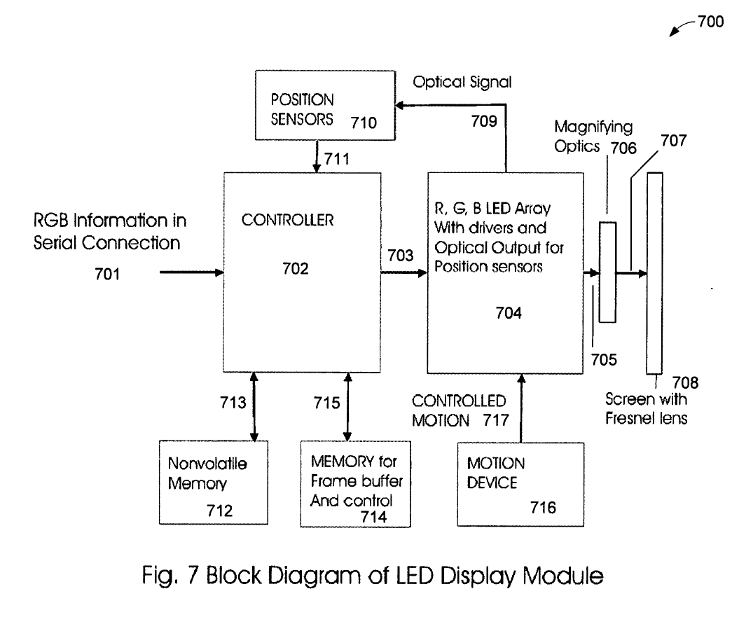

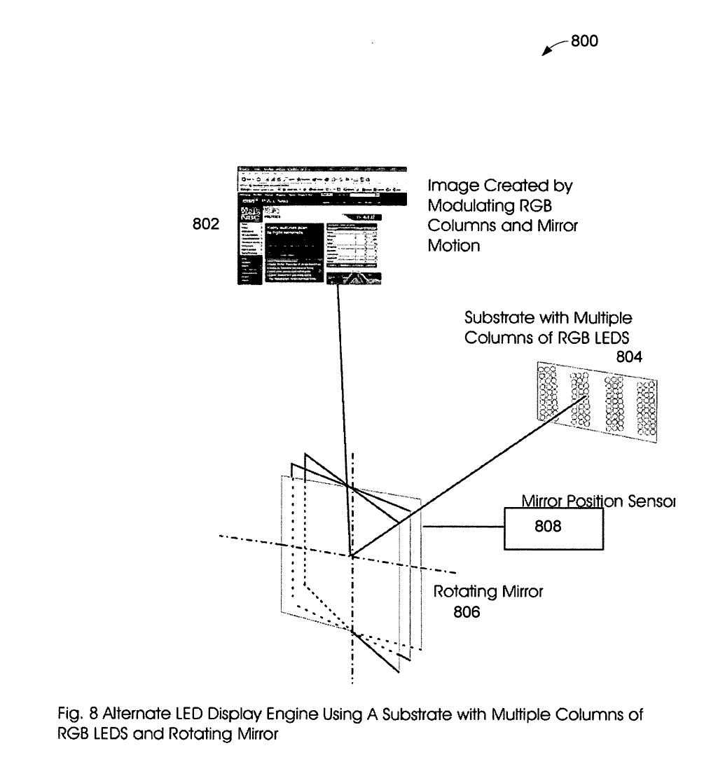

FIG. 5A is a block diagram 500 of one embodiment of a modular LED display. RGB digital video information 501 is sent from the Controller and Director to the display module. The relevant LED drive signals together with the timing information are fed to the LED display engine 502. This may be the engine in FIG. 4, FIG. 7, the alternate engine shown in FIG. 8, or another engine. The LED display engine 502 creates an image of the display to be handled by this module albeit in a smaller size. This image is communicated 503 to a magnification means, such as magnified by the magnifying optics of one or more multi-element aspheric lens 504. These lenses may be made of glass or optical grade plastics. The lenses are designed to minimize distortions, especially chromatic aberrations. These converging rays of the image are communicated 505 and impinge on a screen, such as a non-glare acrylic Fresnel lens screen 506. The Fresnel lens is designed to converge the diverging rays so that they come out substantially perpendicular to the screen.

FIG. 5B shows one embodiment of the invention 550 showing how a module is assembled in a suitable frame to achieve a cross-section. The LED display engine 552 produces a display that is communicated to the magnifying optics 554 which communicates the image from the display engine 552 to the acrylic Fresnel lens screen 556. The lens subassembly (including the magnifying optics 554) is assembled in the mechanical package at the nominal position to create the required magnification on the screen 556. There are adjusting means (such as screws) to change the distance from the LED display engine 552 to the magnifying optics 554 subassembly (“a”) and the distance from the screen 556 to the lenses 554 (“b”). A later discussion will detail the need for adjusting distances “a” and “b”.

In one embodiment of the invention, to minimize the thickness of the modules, and in addition, to get the maximum luminance at the screen, the magnifying lenses are designed to have a low f number. The total thickness of the module is constrained by the fact that the wider the angle of the lens the lower the illumination at the edges. It is known that the luminance of a magnified image at field angle θvaries as the cos⁴ (θ). Thus it is wise to limit the angle to the corner to be less than 45 degrees. The fall off in luminance from the center of the screen to the edges can be compensated somewhat by driving the LEDs at the edges harder (thus producing more luminance) than at the center. The fall off in luminance is symmetrical from the center thus there are comparable falloffs at adjacent tiles and with compensation it is possible to build the tiled displays.

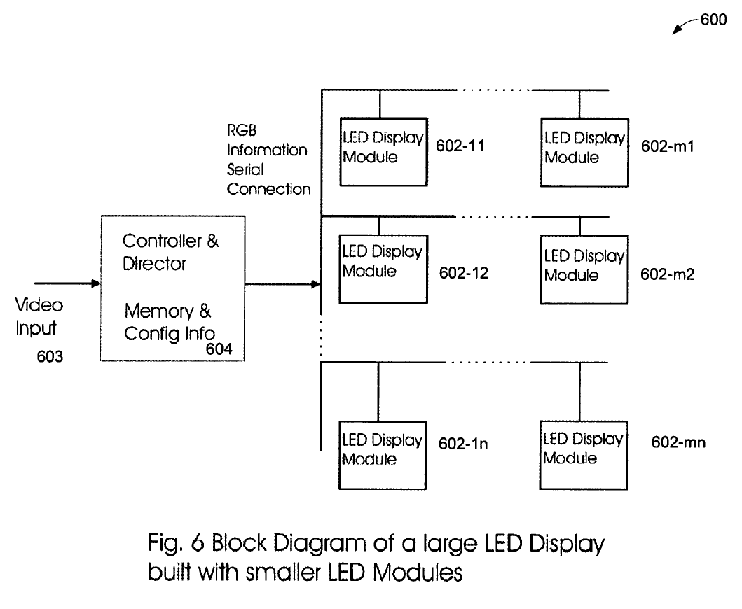

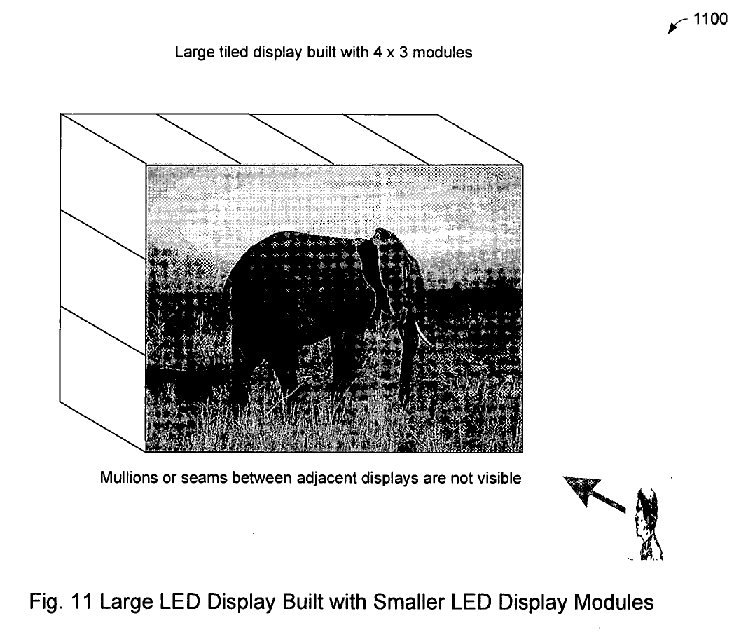

FIG. 6 shows one embodiment of the present invention 600 in block diagram form. The LED display consists of an array of LED display modules (tiles) (602-11 through 602-mn). One such array of 4×3 modules is shown pictorially in FIG. 11 as one embodiment of the invention 1100. The system takes, as input, video 603 in standard digital RGB form such as DVI, HDMI/HDCP or in other VESA standard format. If the video signal is in analog form (such as NTSC, ATSC, PAL, etc.) it is first converted into digital RGB form. The digital RGB signal goes to the controller and director 604. Here the serial digital RGB signal values are captured to store a full frame in the local frame buffer memory. The controller and director 604 may now massage or alter some of the data as will be explained later. Depending on the configuration of the display, stored in the non-volatile memory, the controller and director 604 decides how and which data to send to each of the LED display modules (602-11 through 602-mn). The data rates required here may be high. For example, at a HDTV resolution of 1920 ×1080 pixels and using 8 bits for each R, G, and B pixel and with a refresh rate of 120 Hz, a data rate of 746.496 MBytes/s is required. In one embodiment this data could be sent out serially using multiple 10 Gigabit Ethernet or optical fiber links.

FIG. 7 shows one embodiment of the present invention showing more details in block diagram form. At 701 is RGB information in the form of a serial stream which is communicated to the controller 702. The controller 702 is in communication via 713 with a non-volatile memory 712. The controller 702 is in communication via 715 with a memory for a frame buffer and control 714. The controller 702 is in communication via 711 with position sensors 710. The controller 702 communicates via 703 with a RGB LED array 704 which has drivers, an optical output 705, and an optical output signal 709 for position sensors. The position sensors 710 pick up the optical signal 709 and communicate it to the controller 702 via 711. The RGB LED array 704 also received as input via 717 communications for the motion device 716 which provides controlled motion for the RGB LED array 704. The magnifying optics 706 receives the optical output 705 and communicates it via 707 to the screen with a Fresnel lens 708.

FIG. 8 shows one embodiment of the invention 800 for creating a display 802. In this approach to creating a display engine (unlike that of FIG. 4) the light source is not moved to create the display; rather, the light source, composed of multiple columns of RGB LEDs 804 is held stationary and a mirror 806 is rotated (for example, spun or pivoted) to create the desired image 802. The use of multiple columns of RGB LEDs allows achieving the required brightness because in most cases a single RGB column is not sufficiently bright. Moreover, the RGB LED columns may be spaced at very precise intervals and the display picture painted may be split into regions handled by corresponding RGB columns. The modulation of the LEDs to paint the display image may be synchronized with the rotating mirror via the use of, for example, a mirror position sensor 808. Not shown in FIG. 8 are optics that may be situated between the substrate with multiple columns of RGB LEDS 804 and the rotating mirror 806, and/or optics that may be situated between the rotating mirror 806 and the surface 802 where the image is displayed.

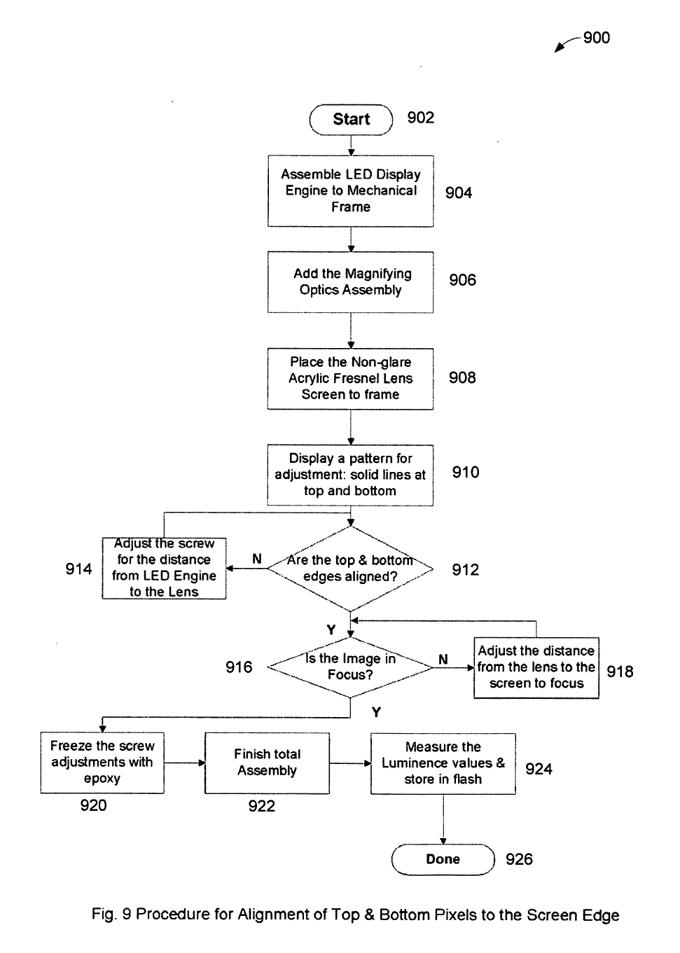

FIG. 9 shows in flowchart form, for one embodiment of the invention 900, the procedure for alignment of top and bottom pixels to the screen edge. First, during manufacture of the LED arrays, the top and bottom LEDs in all the columns may be made the same size, or slightly smaller than the other LEDs in the column. The modular LED display has a mechanical frame to mount the various components. The alignment procedure is as follows:

1. The process is started 902 by assembling 904 the LED display engine onto the mechanical frame.

2. The magnifying optics assembly is added 906 next.

3. The non-glare acrylic Fresnel lens screen is then mounted 908. It should be noted that the assembly so far can be accomplished in any order: 1, 2, 3 or 1, 3, 2 or 2, 1, 3 and so on.

4. A video signal is now applied to the assembly to display suitable patterns for adjustment 910.

5. The top and bottom of the screen are checked to see if the pixels are aligned to the very edge 912. If they are not aligned, the screw that changes the distance from the LED engine to the lens 914 is adjusted to make the alignment.

6. The image on the screen is now checked to make sure that it is in focus 916. If it is not in focus, the other screw that regulates the distance from the lens to the screen is adjusted to focus the image 918. The alignment of the pixels to the edges is checked as well and if necessary adjustments are made (not shown).

7. It is important to ensure that the top and bottom edge alignment is not compromised. Suitable adjustments are made to ensure that the image is in focus and is aligned. The positions of the screws are fixed (for example, using a suitable epoxy) 920. The final assembly, including coverings for the sides and the back are mounted 922. The luminance of the LEDs of the display module is measured and any correction factors are stored in non-volatile memory in the module 924. The display is then completed (done 926).

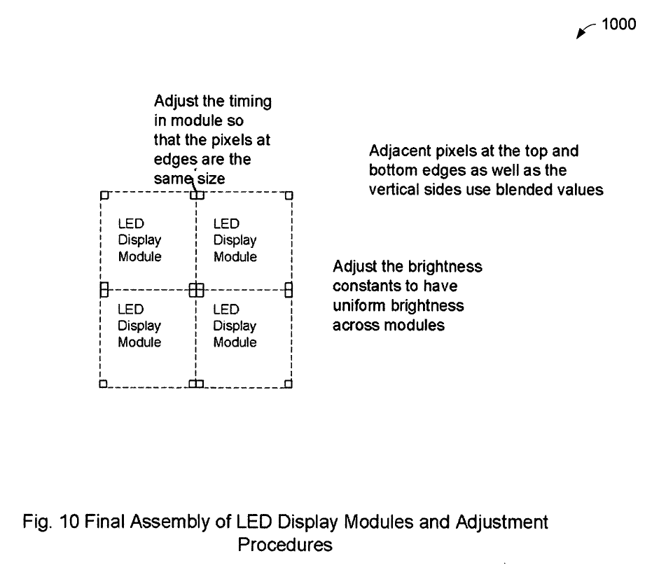

During assembly of a large tiled display, shown such as the embodiment of the invention 1000 shown in FIG. 10, the following steps are taken:

1. The modules are mounted on a rigid mechanical frame so that there is no gap between the modules.

2. A mapping of the modules is entered into the system and stored into the Controller Director chip. For example, if module A is adjacent to module B (B is on the right hand side of A), this information is entered into the system.

3. The Controller Director chip reads the luminance values of all the modules.

4. This information allows the Controller Director chip to create blended values of adjacent pixels on the top, the bottom and the vertical sides as follows:
L_{new=}v L_{old}+(1−v)L_{adj}′

where:

v is the blending factor and usually 0.5<v<1.0

L_{new} is the updated Luminence

L_{old} is the unadjusted Luminance

L_{adj} is the unadjusted adjacent pixel luminance

These are the updated blended LED excitation values sent to the relevant modules.

5. The brightness numbers for the various modules are known by the Controller Director. It is possible to build the modules so that the average luminance is within + or − 10% of the nominal required value. The Controller Director will ensure that at the edges of the modules adjustments are made so that there is no major discernable difference in brightness between adjacent modules. If the differences are held to within +/−2% it should be very hard for an observer to notice any difference.

6. Finally the size of the pixels can be adjusted to make a smooth transition between adjacent modules. This present approach has a major advantage over other tiling technologies because of the ability to change pixel sizes in the x direction dynamically via timing and control of LED excitation.

7. Standard video is now displayed on the large tiled display to confirm a good working display with no seams.

While the above description of FIG. 9 and FIG. 10 illustrate embodiments that may be used by an OEM (original equipment manufacturer) or commercial builder of large displays, the invention is not so limited. For example, in one embodiment an end consumer may construct a large display by purchasing the individual modules and configuring or reconfiguring them by physically placing them together and/or plugging them together. For example, initially a user may only be able to afford a 3×2 array. When the modules are plugged together they may communicate with each other and adjust the image brightness and adjust the image at the edges of the modules so that they appear seamless to the human eye. Likewise the controllers may communicate and decide how the processing of the image as well as the display of the image is to be parceled out. At a later time the user may be able to afford a 16×9 display, for example for high definition. The new modules when connected to the existing 3×2 display may reconfigure all the controllers, adjust the focus, adjust the brightness, etc. to provide a large display. One of skill in the art will appreciate that a computer based system and/or the display controllers may handle such a task. Additionally one of skill in the art will appreciate that communications from one module to another may be wired and/or wireless.

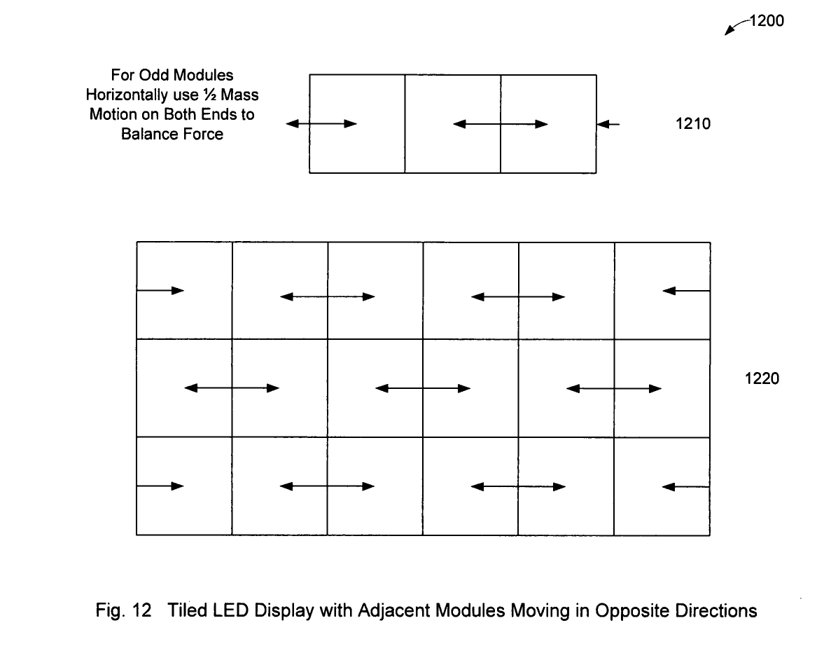

FIG. 12 illustrates embodiments 1210 and 1220 of the invention 1200 having an odd 1210 or even 1220 number of display modules. In order to cancel out substantially any net force on the display due to module movement, for an even number of display modules 1220 in a row (here 6), half the modules may be moving in the opposite direction to the other half. For an odd number of display modules the mass or acceleration may be adjusted to cancel forces. For a given force ½the mass results in ½the force. As one skilled in the art will recall F=ma.

In one embodiment of the invention, each of the LED display modules has mechanical motion to scan the display. In the embodiment shown in FIGS. 5A, 5B and 6, the LED display subassembly may be moved from side to side. In order to minimize vibrations in the final assembly the modules may be configured such that two adjacent modules in a row of a display move in opposite directions. Since the modules are made to be identical if the command is given at the same time to start at the opposite ends at the same time, the net forces on the frame to the right and to the left cancel out. In the case that has an odd number of modules in the x (horizontal) direction the 2 ends can have the same type of mechanical motion with half the mass but both going in the direction to cancel out the net force in the other direction. Since the mechanical assembly is at the back of the screen and smaller in size it does not add any “dead space” that is not lit in the front visible part of the display.

One of skill in the art will appreciate that a module can have a certain nominal resolution and pixel size. However, larger pixel sizes with a corresponding lower resolution can be created by configuring pixels differently. For example, 4 adjacent pixels can create a new square pixel size. For example, consider a 1.2 ft square LED display module with a resolution of 256 ×256 and a pixel size of 1.4 mm which can be reconfigured to have a pixel size of 2.8 mm and resolution of 128 ×128. This can be continued to provide pixels that are 3×or 4×and so on. The required pixel configuration may be stored in the Controller Director. Having a larger pixel built with smaller subpixels allows one to increase the apparent colors observed as one can dither the display with the proper values in the subpixels.

One of skill in the art will appreciate that a display made up of an arrangement of LED based modular displays (“building blocks”) may be made of practically any shape and size. For example, stadium sized displays are possible, as are ones large enough for Times Square, billboards, etc. Additionally, very long displays may also be made. For example, at an airport a display along a wall of a mile or more is possible as is a ring around a stadium. Additionally, irregular shapes may also be created, such as, for example, a stair step pattern, circles, etc.

Thus a method and apparatus for an LED based modular display have been described.

FIG. 1 illustrates a network environment 100 in which the techniques described may be applied. The network environment 100 has a network 102 that connects S servers 104-1 through 104-S, and C clients 108-1 through 108-C. More details are described below.

FIG. 2 illustrates a computer system 200 in block diagram form, which may be representative of any of the clients and/or servers shown in FIG. 1, as well as, devices, clients, and servers in other Figures. More details are described below.

Referring back to FIG. 1, FIG. 1 illustrates a network environment 100 in which the techniques described may be applied. The network environment 100 has a network 102 that connects S servers 104-1 through 104-S, and C clients 108-1 through 108-C. As shown, several computer systems in the form of S servers 104-1 through 104-S and C clients 108-1 through 108-C are connected to each other via a network 102, which may be, for example, a corporate based network. Note that alternatively the network 102 might be or include one or more of: the Internet, a Local Area Network (LAN), Wide Area Network (WAN), satellite link, fiber network, cable network, or a combination of these and/or others. The servers may represent, for example, disk storage systems alone or storage and computing resources. Likewise, the clients may have computing, storage, and viewing capabilities. The method and apparatus described herein may be applied to essentially any type of visual communicating means or device whether local or remote, such as a LAN, a WAN, a system bus, etc. Thus, the invention may find application at both the S servers 104-1 through 104-S, and C clients 108-1 through 108-C.

Referring back to FIG. 2, FIG. 2 illustrates a computer system 200 in block diagram form, which may be representative of any of the clients and/or servers shown in FIG. 1. The block diagram is a high level conceptual representation and may be implemented in a variety of ways and by various architectures. Bus system 202 interconnects a Central Processing Unit (CPU) 204, Read Only Memory (ROM) 206, Random Access Memory (RAM) 208, storage 210, display 220 (for example, embodiments of the present invention), audio, 222, keyboard 224, pointer 226, miscellaneous input/output (I/O) devices 228, and communications 230. The bus system 202 may be for example, one or more of such buses as a system bus, Peripheral Component Interconnect (PCI), Advanced Graphics Port (AGP), Small Computer System Interface (SCSI), Institute of Electrical and Electronics Engineers (IEEE) standard number 1394 (FireWire), Universal Serial Bus (USB), etc. The CPU 204 may be a single, multiple, or even a distributed computing resource. Storage 210, may be Compact Disc (CD), Digital Versatile Disk (DVD), hard disks (HD), optical disks, tape, flash, memory sticks, video recorders, etc. Display 220 might be, for example, an embodiment of the present invention. Note that depending upon the actual implementation of a computer system, the computer system may include some, all, more, or a rearrangement of components in the block diagram. For example, a thin client might consist of a wireless hand held device that lacks, for example, a traditional keyboard. Thus, many variations on the system of FIG. 2 are possible.

For purposes of discussing and understanding the invention, it is to be understood that various terms are used by those knowledgeable in the art to describe techniques and approaches. Furthermore, in the description, for purposes of explanation, numerous specific details are set forth in order to provide a thorough understanding of the present invention. It will be evident, however, to one of ordinary skill in the art that the present invention may be practiced without these specific details. In some instances, well-known structures and devices are shown in block diagram form, rather than in detail, in order to avoid obscuring the present invention. These embodiments are described in sufficient detail to enable those of ordinary skill in the art to practice the invention, and it is to be understood that other embodiments may be utilized and that logical, mechanical, electrical, and other changes may be made without departing from the scope of the present invention.

Some portions of the description may be presented in terms of algorithms and symbolic representations of operations on, for example, data bits within a computer memory. These algorithmic descriptions and representations are the means used by those of ordinary skill in the data processing arts to most effectively convey the substance of their work to others of ordinary skill in the art. An algorithm is here, and generally, conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, can refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

An apparatus for performing the operations herein can implement the present invention. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, hard disks, optical disks, compact disk- read only memories (CD-ROMs), and magnetic-optical disks, read-only memories (ROMs), random access memories (RAMs), electrically programmable read-only memories (EPROM)s, electrically erasable programmable read-only memories (EEPROMs), FLASH memories, magnetic or optical cards, etc., or any type of media suitable for storing electronic instructions either local to the computer or remote to the computer.

The algorithms and displays presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor, or by any combination of hardware and software. One of ordinary skill in the art will immediately appreciate that the invention can be practiced with computer system configurations other than those described, including hand-held devices, multiprocessor systems, microprocessor-based or programmable consumer electronics, digital signal processing (DSP) devices, set top boxes, network PCs, minicomputers, mainframe computers, and the like. The invention can also be practiced in distributed computing environments where tasks are performed by remote processing devices that are linked through a communications network.

The methods of the invention may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application, driver, . . . ), as taking an action or causing a result. Such expressions are merely a shorthand way of saying that execution of the software by a computer causes the processor of the computer to perform an action or produce a result.

It is to be understood that various terms and techniques are used by those knowledgeable in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as a formula, algorithm, or mathematical expression. Thus, one of ordinary skill in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical embodiment in at least hardware and/or software (such as a computer system in which the techniques of the present invention may be practiced as well as implemented as an embodiment).

A machine-readable medium is understood to include any mechanism for storing or transmitting information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

As used in this description, “one embodiment” or “an embodiment” or similar phrases means that the feature(s) being described are included in at least one embodiment of the invention. References to “one embodiment” in this description do not necessarily refer to the same embodiment; however, neither are such embodiments mutually exclusive. Nor does “one embodiment” imply that there is but a single embodiment of the invention. For example, a feature, structure, act, etc. described in “one embodiment” may also be included in other embodiments. Thus, the invention may include a variety of combinations and/or integrations of the embodiments described herein.

Thus a method and apparatus for a light emitting device (LED) based modular display have been described.

What is claimed is:

1. A method comprising:
receiving a signal representing an image; and
controlling a plurality of light emitting device (LED) based modular displays based on said received signal.

2. The method of claim 1 wherein one or more of said plurality of LED based modular displays further comprises one or more light emitting devices.

3. The method of claim 2 wherein said controlling further comprises controlling the activation of said one or more light emitting devices.

4. The method of claim 3 wherein said activation of said one or more light emitting devices further comprises controlling the intensity of said one or more light emitting devices.

5. The method of claim 4 wherein said controlling the intensity further comprises controlling said intensity based upon a factor determined from a measurement of a test pattern image.

6. The method of claim 4 further comprising mounting one or more of said plurality of LED based modular displays in a pattern capable of displaying said image across one or more of said LED based modular displays.

7. The method of claim 6 further comprising adjusting said mounting such that said image appears seamless to an unaided human eye across said one or more of said plurality of LED based modular displays in said pattern.

8. The method of claim 6 further comprising manipulating said controlling said intensity such that said image appears seamless in display intensity to an unaided human eye across said one or more of said plurality of LED based modular displays in said pattern.

9. The method of claim 2 wherein controlling further comprises moving one or more of said light emitting devices.

10. The method of claim 9 wherein said moving further comprises moving substantially at a resonant frequency said one or more light emitting devices.

11. The method of claim 10 further comprising locating between said one or more of said plurality of LED based modular displays and a surface displaying said image one or more optical elements.

12. The method of claim 10 further comprising coupling one or more optical elements to one or more of said plurality of LED based modular displays.

13. The method of claim 10 wherein said moving further comprises moving one or more of said light emitting devices in opposite directions.

14. The method of claim 2 further comprising optically coupling one or more of said plurality of LED based modular displays to a mirror.

15. The method of claim 14 wherein said mirror has a motion selected from the group consisting of rotating, pivoting, and oscillating.

16. The method of claim 1 wherein each of said LED based modular displays processes less than a full frame of said image.

17. An apparatus comprising:
a plurality of light emitting device (LED) based modular displays mounted in an optical plane and capable of producing an optical output;
one or more optical elements having an input and an output, said one or more optical elements input coupled to receive said LED based modular displays' optical output; and
a surface coupled to receive the optical output of said one or more optical elements.

18. The apparatus of claim 17 wherein one or more of said light emitting device based modular displays has one or more columns of light emitting diodes.

19. The apparatus of claim 18 wherein one or more of said one or more columns of light emitting diodes are moving at substantially a resonant frequency.

20. The apparatus of claim 19 wherein one or more of said one or more columns of light emitting diodes are moving in opposite directions.

21. An apparatus comprising:
means for receiving a signal representing an image;
means for controlling the movement of one or more light emitting devices in a columnar arrangement;
means for controlling the excitation of one or more of said one or more light emitting devices in said columnar arrangement based on said received signal; and
means for coupling an optical output from said one or more light emitting devices in said columnar arrangement to a viewing surface.

22. A display apparatus comprising:
a plurality of reconfigurable display modules wherein said reconfigurable display modules have a moving mass, and
if said plurality is an even number then half of said reconfigurable display modules' moving mass is moving in an opposite direction to the other half;
if said plurality is an odd number then one or more of said reconfigurable display modules' moving mass, or acceleration of said mass, is adjusted to substantially cancel any net force on said display.

23. An apparatus comprising:
a plurality of columns of light emitting devices capable of producing an optical output; and
one or more mirror elements capable of receiving said optical output and reflecting said received optical output onto a viewing surface.

24. The apparatus of claim 23 wherein one or more of said one or more mirror elements has a motion selected from the group consisting of rotating and pivoting.

25. The apparatus of claim 24 wherein more than one of said plurality of columns of light emitting devices is used to produce an image.

26. The apparatus of claim 24 wherein a light emitting device from more than one column of said plurality of columns is used to produce a same pixel of an image.

27. The apparatus of claim 26 wherein said plurality of columns of light emitting devices are not moving.

28. The apparatus of claim 27 wherein each column of said plurality of columns of light emitting devices do not produce light at exactly the same time.
